(19) United States
(12) Patent Application Publication
(10) Pub. No.: US 2024/0107291 A1
(43) Pub. Date: Mar. 28, 2024

(54) EDGE-ANCHORED INDICATIONS FOR USER EQUIPMENT (UE) COMMUNICATIONS

(71) Applicant: Apple Inc., Cupertino, CA (US)

(72) Inventor: Sudeep Manithara Vamanan, Uttenreuth (DE)

(73) Assignee: Apple Inc., Cupertino, CA (US)

(21) Appl. No.: 18/462,168

(22) Filed: Sep. 6, 2023

Related U.S. Application Data
(60) Provisional application No. 63/411,014, filed on Sep. 28, 2022.

(51) Int. Cl. H04W 8/20; H04W 48/08; H04W 48/16

(52) U.S. Cl. CPC H04W 8/20; H04W 48/08; H04W 48/16

(57) ABSTRACT

The present application relates to controlling the use of edge-anchored indications for a UE. In an example, a UE can communicate with an edge entity via a network. The network can determine based on one or a combination of UE authorization or AF authorization whether the related traffic is to be edge-anchored or not. Edge anchoring the traffic can help avoid the UE switching the traffic to an alternate network that may be available to the UE. The network can send an edge-anchored indication to the UE accordingly.

### CROSS REFERENCE TO RELATED APPLICATIONS

The present application claims the benefit and priority under 35 U.S.C. 119(e) of U.S. Provisional Patent Application No. 63/411,014, filed Sep. 28, 2022, entitled, “EDGE-ANCHORED INDICATIONS FOR USER EQUIPMENT (UE) COMMUNICATIONS,” the content of which is herein incorporated by reference in its entirety for all purposes.

### BACKGROUND

Cellular communications can be defined in various standards to enable communications between a user equipment and a cellular network. For example, Fifth generation mobile network (5G) is a wireless standard that aims to improve upon data transmission speed, reliability, availability, and more.

### BRIEF DESCRIPTION OF THE DRAWINGS

FIG. 1 illustrates an example of a 5G network architecture that incorporates both 3GPP (e.g., cellular) and non-3GPP (e.g., non-cellular) access to the 5G core network, in accordance with some embodiments.

FIG. 2 illustrates an example of a 5G network architecture that incorporates both dual 3GPP (e.g., LTE and 5G NR) access and non-3GPP access to the 5G core network, in accordance with some embodiments.

FIG. 3 illustrates an example of a core network (CN), in accordance with some embodiments, in accordance with some embodiments.

FIG. 4 illustrates an example of edge anchoring of user equipment (UE) communications, in accordance with some embodiments.

FIG. 5 illustrates an example of UE authorization-based edge anchoring, in accordance with some embodiments.

FIG. 6 illustrates an example of a sequence diagram for UE authorization-based edge anchoring, in accordance with some embodiments.

FIG. 7 illustrates an example of policy-based edge anchoring, in accordance with some embodiments.

FIG. 8 illustrates an example of dynamic connection conditions-based edge anchoring, in accordance with some embodiments.

FIG. 9 illustrates an example of a sequence diagram for dynamic connection conditions-based edge anchoring, in accordance with some embodiments.

FIG. 10 illustrates another example of a sequence diagram for dynamic connection conditions-based edge anchoring, in accordance with some embodiments.

FIG. 11 illustrates an example of application function (AF) authorization-based edge anchoring, in accordance with some embodiments.

FIG. 12 illustrates an example of an operational flow/algorithmic structure for edge anchoring of UE communications, in accordance with some embodiments.

FIG. 13 illustrates another example of an operational flow/algorithmic structure for edge anchoring of UE communications, in accordance with some embodiments.

FIG. 14 illustrates an example of receive components, in accordance with some embodiments.

FIG. 15 illustrates an example of a UE, in accordance with some embodiments.

FIG. 16 illustrates an example of a base station, in accordance with some embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth, such as particular structures, architectures, interfaces, techniques, etc., in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrase “A or B” means (A), (B), or (A and B).

Generally, a first network (e.g., a Third Generation Partnership Project (3GPP) New Radio (NR) cellular network) can facilitate communications of a user equipment (UE) with an edge entity. As used herein, an edge entity refers to an edge application server (EAS), an edge application function (EAF), or any other node or service for edge computing. A second network (e.g., a WiFi network, a non-3GPP cellular network, etc.) may also be available to the UE and capable of facilitating the communications with the edge entity. In certain situations, it may be desired to avoid a UE switch of traffic between the UE and the edge entity (e.g., traffic of a protocol data unit (PDU) session) from being sent via the first network to being sent via the second network. In such situations, an edge-anchored indication can be used, whereby the first network can send this indication to the UE, and whereby the UE can use this indication to possibly avoid the UE switch.

In some examples, edge-anchored indications are sent to the UE based on any or a combination of a UE authorization, a policy, network connectivity conditions, or an application function (AF) authorization. For example, subscription data of the UE can explicitly or implicitly indicate an authorization for edge-anchored indications. Policy and charging control (PCC) rule information can include policy indicating that edge-anchored indications apply to some or all traffic with the UE. Based on changes to a network connectivity condition, a request of the edge entity can be received and processed to update the policy and/or send, to the UE an edge-anchored indication related to the corresponding traffic or, conversely, to indicate that the edge-anchored indication is no longer usable. Such and other requests can be received from an AF. An authorization of the AF to request setting of traffic switching indications can be verified. These and other functionalities are further described herein below.

Embodiments of the present disclosure are described in connection with 5G networks. However, the embodiments are not limited as such and similarly apply to other types of communication networks including other types of cellular networks.

The following is a glossary of terms that may be used in this disclosure.

The term “circuitry” as used herein refers to, is part of, or includes hardware components, such as an electronic circuit, a logic circuit, a processor (shared, dedicated, or group) or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, or transferring digital data. The term “processor circuitry” may refer to an application processor, baseband processor, a central processing unit (CPU), a graphics processing unit, a single-core processor, a dual-core processor, a triple-core processor, a quad-core processor, or any other device capable of executing or otherwise operating computer-executable instructions, such as program code, software modules, or functional processes.

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Examples include a cellular phone, a tablet, a laptop, a desktop computer, a wearable device, a smart appliance, an internet of things (IoT) device, sensor devices, and the like. Furthermore, the term “user equipment” or “UE” may include any type of wireless/wired device or any computing device including a wireless communications interface.

The term “base station” as used herein refers to a device with radio communication capabilities, that is a network component of a communications network (or, more briefly, a network), and that may be configured as an access node in the communications network. A UE's access to the communications network may be managed at least in part by the base station, whereby the UE connects with the base station to access the communications network. Depending on the radio access technology (RAT), the base station can be referred to as a gNodeB (gNB), eNodeB (eNB), access point, etc.

The term “network” as used herein reference to a communications network that includes a set of network nodes configured to provide communications functions to a plurality of user equipment via one or more base stations. For instance, the network can be a public land mobile network (PLMN) that implements one or more communication technologies including, for instance, 5G communications.

The term “computer system” as used herein refers to any type of interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component within a computing environment, or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, or the like. A “hardware resource” may refer to compute, storage, or network resources provided by physical hardware element(s). A “virtualized resource” may refer to compute, storage, or network resources provided by virtualization infrastructure to an application, device, system, etc. The term “network resource” or “communication resource” may refer to resources that are accessible by computer devices/systems via a communications network. The term “system resources” may refer to any kind of shared entities to provide services, and may include computing or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link” as used herein refers to a connection between two devices for the purpose of transmitting and receiving information.

The terms “instantiate,” “instantiation,” and the like as used herein refer to the creation of an instance. An “instance” also refers to a concrete occurrence of an object, which may occur, for example, during execution of program code.

The term “connected” may mean that two or more elements, at a common communication protocol layer, have an established signaling relationship with one another over a communication channel, link, interface, or reference point.

The term “network element” as used herein refers to physical or virtualized equipment or infrastructure used to provide wired or wireless communication network services. The term “network element” may be considered synonymous to or referred to as a networked computer, networking hardware, network equipment, network node, virtualized network function, or the like.

The term “information element” refers to a structural element containing one or more fields. The term “field” refers to individual contents of an information element, or a data element that contains content. An information element may include one or more additional information elements.

The term “3GPP Access” refers to accesses (e.g., radio access technologies) that are specified by 3GPP standards. These accesses include, but are not limited to, GSM/GPRS, LTE, LTE-A, and/or 5G NR. In general, 3GPP access refers to various types of cellular access technologies.

The term “Non-3GPP Access” refers any accesses (e.g., radio access technologies) that are not specified by 3GPP standards. These accesses include, but are not limited to, WiMAX, CDMA2000, Wi-Fi, WLAN, and/or fixed networks. Non-3GPP accesses may be split into two categories, “trusted” and “untrusted”: Trusted non-3GPP accesses can interact directly with an evolved packet core (EPC) and/or a 5G core (5GC), whereas untrusted non-3GPP accesses interwork with the EPC/5GC via a network entity, such as an Evolved Packet Data Gateway and/or a 5G NR gateway. In general, non-3GPP access refers to various types on non-cellular access technologies.

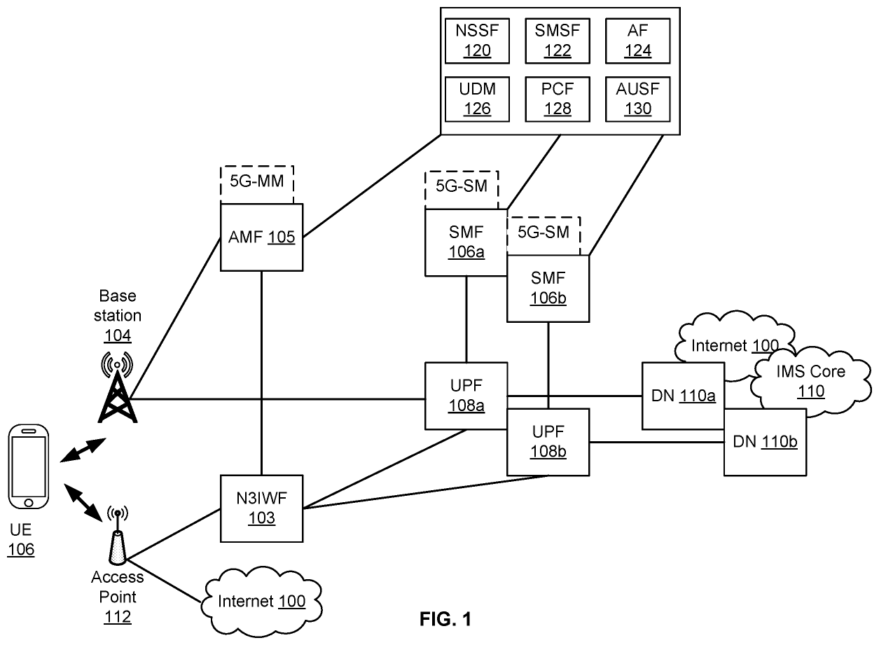

FIG. 1 illustrates an example of a 5G network architecture that incorporates both 3GPP (e.g., cellular) and non-3GPP (e.g., non-cellular) access to a 5G core network (CN), in accordance with some embodiments. As shown, a UE 106 may access the 5G CN through both a radio access network (RAN, e.g., a base station 104 that can be a gNB) and an access point (AP) 112. The AP 112 may include a connection to the Internet 100 as well as a connection to a non-3GPP inter-working function (N3IWF) 103 network entity. The N3IWF may include a connection to a core access and mobility management function (AMF) 105 of the 5G CN. The AMF 105 may include an instance of a 5G mobility management (5G MM) function associated with the UE 106. In addition, the RAN (e.g., the base station 104) may also have a connection to the AMF 105. Thus, the 5G CN may support unified authentication over both connections as well as allow simultaneous registration for UE 106 access via both gNB 104 and AP 112. As shown, the AMF 105 may include one or more functional entities associated with the 5G CN (e.g., network slice selection function (NSSF) 120, short message service function (SMSF) 122, application function (AF) 124, unified data management (UDM) 126, policy control function (PCF) 128, and/or authentication server function (AUSF) 130). Note that these functional entities may also be supported by a session management function (SMF) 106a and an SMF 106b of the 5G CN. The AMF 105 may be connected to (or in communication with) the SMF 106a. Further, the base station 104 may be in communication with (or connected to) a user plane function (UPF) 108a that may also be in communication with the SMF 106a. Similarly, the N3IWF 103 may be communicating with a UPF 108b that may also be communicating with the SMF 106b. Both UPFs may be communicating with the data network (e.g., DN 110a and 110b) and/or the Internet 100 and Internet Protocol (IP) Multimedia Subsystem/IP Multimedia Core Network Subsystem (IMS) core network 110.

Generally, base station 104 communicates over a transmission medium with one or more UEs (e.g., including the UE 106). Each of the user devices may be referred to herein as a “user equipment” (UE). The base station (BS) 104 may be a base transceiver station (BTS) or cell site (a “cellular base station”) and may include hardware that enables wireless communication with the UE 106.

The communication area (or coverage area) of the base station 104 may be referred to as a “cell.” The base station 104 and the UE 106 may be configured to communicate over the transmission medium using any of various radio access technologies (RATs), also referred to as wireless communication technologies, or telecommunication standards, such as GSM, UMTS (associated with, for example, WCDMA or TD-SCDMA air interfaces), LTE, LTE-Advanced (LTE-A), 5G new radio (5G NR), HSPA, 3GPP2 CDMA2000 (e.g., 1×RTT, 1×EV-DO, HRPD, eHRPD), etc. If the base station 104 is implemented in the context of LTE, it may alternately be referred to as an ‘eNodeB’ or ‘eNB’. If base station 104 is implemented in the context of 5G NR, it may alternately be referred to as ‘gNodeB’ or ‘gNB’.

The base station 104 may also be equipped to communicate with a network (e.g., a core network of a cellular service provider, such as the 5G CN, a telecommunication network, such as a public switched telephone network (PSTN), and/or the Internet, among various possibilities). Thus, the base station 104 may facilitate communication between the user devices and/or between the UE 106 and the network. In particular, the cellular base station 104 may provide UEs 106 with various telecommunication capabilities, such as voice, SMS, and/or data services.

The base station 104 and other similar base stations operating according to the same or a different cellular communication standard may thus be provided as a network of cells, which may provide continuous or nearly continuous overlapping service to UE 106 and similar devices over a geographic area via one or more cellular communication standards.

Thus, while base station 104 may act as a “serving cell” for UE 106 as illustrated in FIG. 1, the UE 106 may also be capable of receiving signals from (and possibly within communication range of) one or more other cells, which may be referred to as “neighboring cells.” Such cells may also be capable of facilitating communication between user devices and/or between user devices and the network 100. Such cells may include “macro” cells, “micro” cells, “pico” cells, and/or cells which provide any of various other granularities of service area size.

In some embodiments, the base station 104 may be a next generation base station, e.g., a 5G New Radio (5G NR) base station, or “gNB”. In some embodiments, a gNB may also be connected to a legacy evolved packet core (EPC) network and/or to a NR core (NRC) network. In addition, a gNB cell may include one or more transition and reception points (TRPs). In addition, a UE capable of operating according to 5G NR may be connected to one or more TRPs within one or more gNBs.

The UE 106 may be capable of communicating using multiple wireless communication standards. For example, the UE 106 may be configured to communicate using a wireless networking (e.g., Wi-Fi) and/or peer-to-peer wireless communication protocol (e.g., Bluetooth, Wi-Fi peer-to-peer, etc.) in addition to at least one cellular communication protocol (e.g., GSM, UMTS (associated with, for example, WCDMA or TD-SCDMA air interfaces), LTE, LTE-A, 5G NR, HSPA, 3GPP2 CDMA2000 (e.g., 1×RTT, 1×EV-DO, HRPD, eHRPD), etc.). The UE 106 may also or alternatively be configured to communicate using one or more global navigational satellite systems (GNSS, e.g., GPS or GLONASS), one or more mobile television broadcasting standards (e.g., ATSC-M/H or DVB-H), and/or any other wireless communication protocol, if desired. Other combinations of wireless communication standards (including more than two wireless communication standards) are also possible.

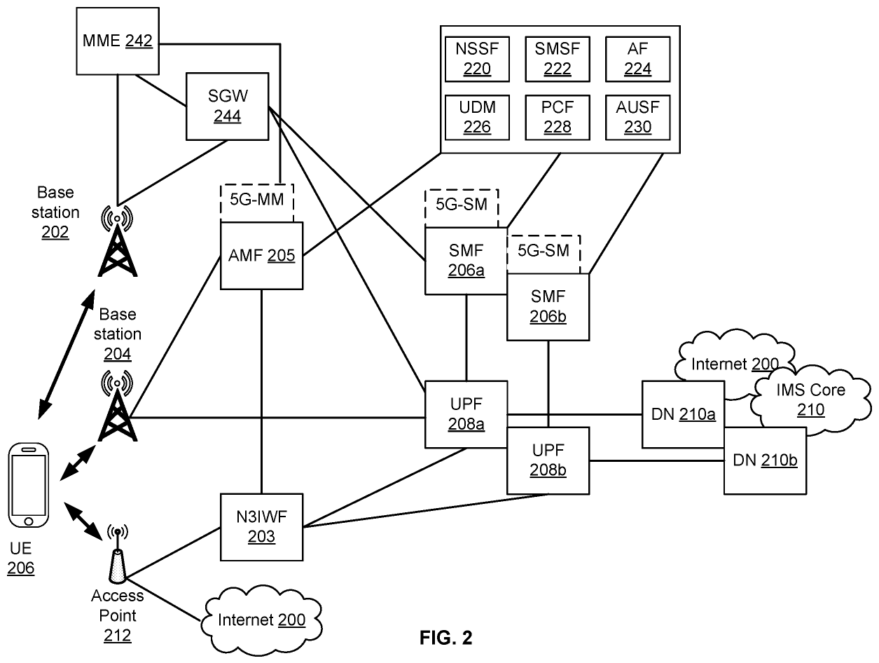

FIG. 2 illustrates an example of a 5G network architecture that incorporates both dual 3GPP (e.g., LTE and 5G NR) access and non-3GPP access to the 5G CN, in accordance with some embodiments. As shown, a UE 206 may access the 5G CN through both a RAN (e.g., a base station 204, such as gNB) and an AP 212. The AP 212 may include a connection to the Internet 200 as well as a connection to a N3IWF 203 network entity. The N3IWF 203 may include a connection to an AMF 205 of the 5G CN. The AMF 205 may include an instance of a 5G MM function associated with the UE 206. In addition, the RAN (e.g., the base station 204) may also have a connection to the AMF 205. Thus, the 5G CN may support unified authentication over both connections as well as allow simultaneous registration for UE 206 access via both the base station 204 and the AP 212. In addition, the 5G CN may support dual-registration of the UE 106 on both a legacy network (e.g., LTE via a base station 202, such as an eNB) and a 5G network (e.g., via the base station 204). As shown, the base station 202 may have connections to a mobility management entity (MME) 242 and a serving gateway (SGW) 244. The MME 242 may have connections to both the SGW 244 and the AMF 205. In addition, the SGW 244 may have connections to both an SMF 206a and an UPF 208a. As shown, the AMF 205 may include one or more functional entities associated with the 5G CN (e.g., NSSF 220, SMSF 222, AF 224, UDM 226, PCF 228, and/or AUSF 230). The UDM 226 may also include a home subscriber server (HSS) function and the PCF 228 may also include a policy and charging rules function (PCRF). These functional entities may also be supported by an SMF 606a and an SMF 206b of the 5G CN. The AMF 205 may be connected to (or in communication with) the SMF 206a. Further, the base station 204 may be in communication with (or connected to) the UPF 208a that may also be in communication with the SMF 206a. Similarly, the N3IWF 203 may be communicating with a UPF 208b that may also be communicating with an SMF 206b. Both UPFs may be communicating with the data network (e.g., DN 210a and 210b) and/or the Internet 200 and an IMS core network 210.

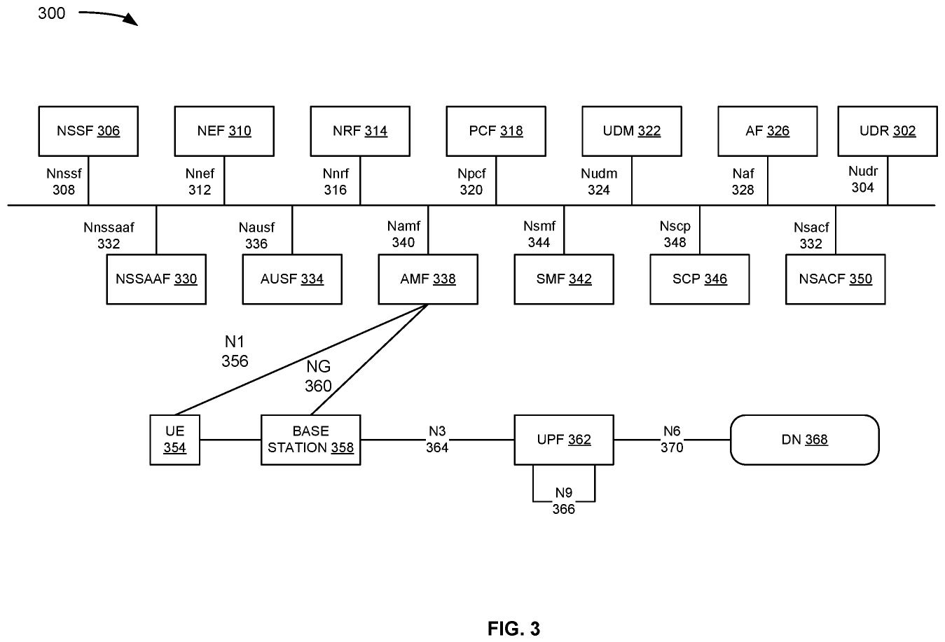

FIG. 3 illustrates an example of a CN 300, in accordance with some embodiments, in accordance with some embodiments. The CN 300 can include a 5G CN, such as any of the 5G CN described in FIGS. 1 and 2. It should be appreciated that the CN 300 can be a different generation CN, such as a sixth generation (6G) CN.

The CN 300 includes a network splice selection function (NSSF) 306. The NSSF 306 can be a control plane function that can verify that a UE is subscribed to each of the single network slice selection information (S-NSSAI) belonging to a requested S-NSSAI, select one or more network slices to serve the UE and generate an Allowed NSSAI, and identify a set of candidate access and mobility function (AMF) to serve the UE. The NSSF 306 can communicate with the CN 300 via an Nnssf 308, a control plane interface exhibited by the NSSF 306. The CN 300 can further include a network exposure function (NEF) 310. The NEF 310 can be a control plane function that can provide information about NFs within the CN 300 to external NFs. The NEF 310 can communicate with the CN 300 via an Nnef 312, a control plane interface exhibited by the NEF 310. The CN 300 can further include a network repository function (NRF) 314. The NRF 314 can be a control plane function that allows NFs to register their services and allows other NFs to discover those services. The NRF 314 can communicate with the CN 300 via an Nnrf 316, a control plane interface exhibited by the NRF 314. The CN 300 can further include a policy control function (PCF) 318. The PCF 318 can be a control plane function responsible for providing policies associated with mobility management and policies associated with session management. The PCF 318 can communicate with the CN 300 via an Npcf 320, an interface exhibited by the PCF 318. The CN 300 can further include a unified data management (UDM) 322. The UDM 322 can be a control plane function that manages subscriber data and store subscriber data. The UDM 322 can communicate with the CN 300 via an Nudm 324, a control plane interface exhibited by the UDM 322. The CN 300 further includes an application function (AF) 326. The AF 326 can be a control plane function that acts as a server for providing support for specific services. The AF 326 can communicate with the CN 300 via an Naf 328, a control plane interface exhibited by the AF 326. In addition, the CN 300 can include a unified data repository (UDR) 302. The UDR 302 can be configured as a centralized data repository for subscription data, subscriber policy data, sessions, contexts, and application states and can provide notifications to other network function about updates to, for example, subscription data. The UDR 322 can communicate with the CN 300 via an Nudr 304, a control plane interface exhibited by the UDR 302.

The CN 300 can further include a network slice specific authentication and authorization function (NSSAAF) 330. The NSSAAF 330 can be a control plane function that can support network splice-specific authentication and authorization. The NSSAAF 330 can communicate with the CN 300 via an Nnssaaf 332, an interface exhibited by the NSSAAF 330. The CN 300 can further include an authentication server function (AUSF) 334. The AUSF 334 is a control plane function that can support both subscriber and network authentication. The AUSF 334 can communicate with the CN 300 via an Nausf 336, an interface exhibited by the AUSF 334. The CN 300 can further include an AMF 338. The AMF 338 can be a control plane function whose responsibilities include registration management, connection management, reachability management, and mobility management. The AMF 338 can communicate with the CN 300 via an Namf 340, an interface exhibited by the AMF 338. The Namf 340 is configured to receive messages from the base station 358 via the AMF 338.

The CN 300 can further include a session management function (SMF) 342. The SMF 342 can be a control plane function whose responsibilities include packet data unit (PDU) session management, internet protocol (IP) address allocation, and general packet radio service (GPRS) protocol (GTP-U) tunnel management. The SMF 342 can communicate with the CN 300 via an Nsmf 344, an interface exhibited by the SMF 342. The CN 300 can further include a service communication proxy (SCP) 346. The SCP 346 can be a control plane function that can provide routing control and observability for the CN 300. The SCP 346 can communicate with the CN 300 via an Nscp 348, an interface exhibited by the SCP 346. The CN 300 can further include a network slice administration control function (NSACF) 350. The NSACF 350 can be a control plane function that monitors and controls the number of registers UEs per network slice. The NSACF 350 can communicate with the CN 300 via a Nnsacf 352, an interface exhibited by the NSACF 350.

The CN 300 can be in operable communication with a UE 354. The UE 354 can communicate with the CN 300 via an N1 interface (N1) 356. The UE 354 can be in communication with a base station 358. The UE 354 can also communicate with the CN 300 via the base station 358. The base station 358 can communicate with the CN 300 via an NG (also known as “N2”) 360.

The base station 358 can communicate with a user plane function (UPF) 362 via an N3 interface (N3) 364. The UPF 362 can include an intermediate UPF (I-UPF) and a UPF session anchor. The I-UPF can communicate with the UPF session anchor via an N9 interface (N9) 366. The UPF 362 can be responsible for routing and forward to user plane packets to an external data network 368 via an N6 interface (N6) 370.

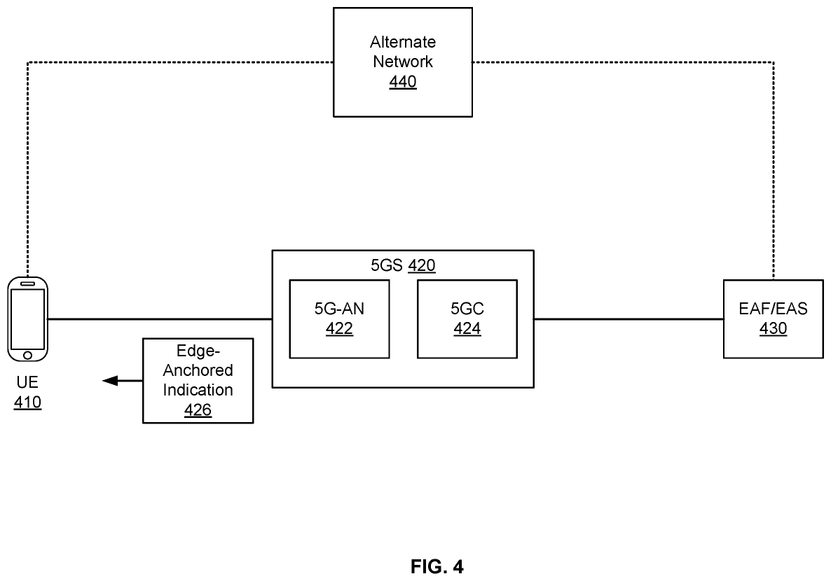

FIG. 4 illustrates an example of edge anchoring of UE communications, in accordance with some embodiments. A UE 410 can communicate with an edge entity 430 (shown as an edge application function and/or an edge application server) via a 5G system (5GS) 420 that includes a 5G access network (5G-AN) 522 and a 5G core network (5GC) 424 and that represents a 3GPP cellular network of a mobile network operator (MNO). For example, a PDU session can be established, whereby the 5GCS 420 can facilitate the traffic between the UE 410 and the edge entity 430. The 5G-AN 522 can include, among other things, a base station (e.g., a gNB). The 5GC 424 can be an example of the CN 300 of FIG. 3. An alternate network 440 may also be available to the UE 410, where the traffic between the UE 410 and the edge entity 430 can be sent via the alternate network 440 instead of the 5GS 420 (e.g., by using another data session). The alternate network can be a WiFi network, a WiMax network, a non-3GPP network, or any other type of networks.

It may be desired to avoid a UE switch of the traffic from being sent via the 5GS 420 to being sent via the alternate network 420. For example, depending on agreements between the MNO and an operator, provider, or owner of the edge component 430, connectivity requirements (e.g.., latency, throughput, etc.), or other parameters, the traffic may need to be served by the 5GS 420 only when this 3GPP cellular network is available. In such situations, an edge-anchored indication 426 can be used, whereby the 5GS 420 sends this indication 426 to the UE 410 (e.g., an SMF of the 5GC 424 sends it via a base station of the 5G-AN 422), and whereby the UE 410 can use this indication 426 to possibly avoid the UE switch. Avoiding the switch is illustrated in FIG. 4 by using dotted lines between the UE 410 and the alternate network 440 and between the alternate network 440 and the edge entity 430.

Generally, the edge-anchored indication 426 includes information indicating to the UE 410 that the traffic, or more broadly, the PDU session is edge-anchored. An edge-anchored PDU session represents a PDU session that provides connectivity to an edge entity (e.g., the edge entity 430 in FIG. 4), where this connectivity cannot be relocated. In an example, the edge-anchored indication 426 include any or a combination of UE route selection policy (URSP) rule selection descriptor (RSD) fields to indicate whether the PDU session is edge-anchored. In another example, during a PDU session establishment or modification, the edge-anchored indication 426 can be provided using extended protocol configuration options (ePCO) information elements (IEs). In this example, the edge-anchored indication 426 can merely indicate that the PDU session (or the traffic) is edged-anchored or can provide additional information, such as the PDU session (or the traffic) being edged-anchored and 5GC preferred (e.g., preference is to use the 5GS 420), or such as the PDU session (or the traffic) being edged-anchored and 3GPP access preferred (e.g., preference is to use a 3GPP cellular network).

In certain situations, the edge-anchored indication 426 can be provided based on any or a combination of a UE authorization, a policy, network connectivity conditions, or an AF authorization. For example, the edge-anchored indication 426 may be provided only to a subset of UEs connected to the 5GS 420 (e.g., to UEs that are authorized to use the edge deployment or require edge-anchored indications). In another example, the edge-anchored indication 426 may apply only to a subset of applications. In particular, not all application traffic may require edge-anchoring. Edge-anchored indications may only be provisioned if specific applications have been detected and a policy is in place to anchor traffic of that application to edge hosting environment of the MNO. In yet another example, UE connectivity conditions may dynamically change. The UE 410 may be able to reach the same edge entity 430 via the alternate network 440 so that there is no break in connectivity. Or, the UE 410 may have alternate access that may be providing better connectivity that the 5GS 420 may not be aware of. In these cases, an AF of the 5GC 424 needs to be able to control the edge-anchored indications of the 5GS 420 that may prevent the UE 410 from getting a better user experience for the application traffic. In a further example, if the UE 410 has been given an indication that application traffic should consider cellular connectivity as edge anchored (or any of its variants), the UE 410 may not switch traffic over non-3GPP connections that the UE 410 may find. This can be misused by unauthorized AFs or due to misconfigurations in the networks. In such cases, edge-anchored indications can be provided to the UE 410 about an authorization of an AF. These and other controls over the use of edge-anchored indications are further described in connection with the next figures.

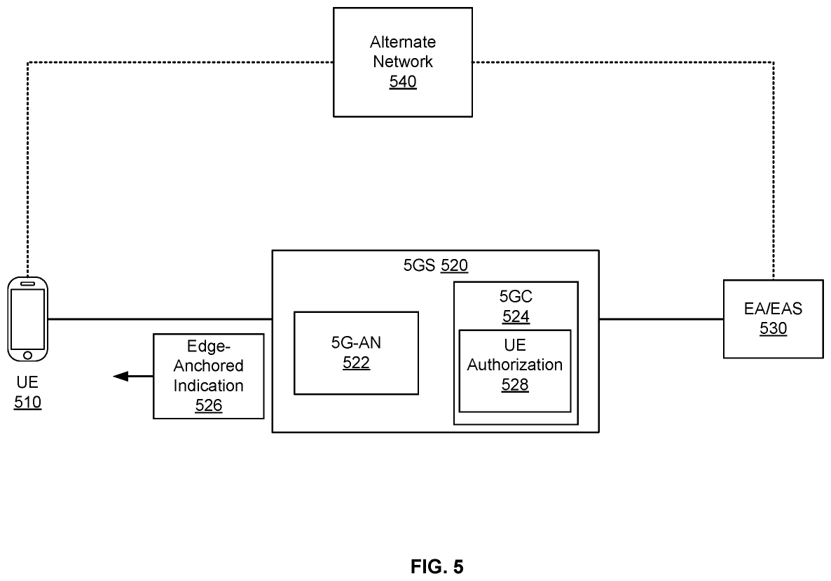

FIG. 5 illustrates an example of UE authorization-based edge anchoring, in accordance with some embodiments. Generally, a UE authorization for an edge-anchored indication is determined first to then provide the edge-anchored indication to the relevant UE.

In the illustration of FIG. 5, a UE 510 can communicate with an edge entity 530 (shown as an edge application function and/or an edge application server) via a 5GS 520 that includes a 5G-AN 522 and a 5GC 524 and that represents a 3GPP cellular network of an MNO. A PDU session can be established, whereby the 5GCS 520 can facilitate the traffic between the UE 510 and the edge entity 530. An alternate network 540 may also be available to the UE 510, where the traffic between the UE 510 and the edge entity 530 can be sent via the alternate network 540 instead of the 5GS 520 (e.g., by using another data session). The UE 510, the 5GS 520, the 5G-AN 522, the 5GC 524, the edge entity 530, and the alternate network 540 can be similar to the UE 410, the 5GS 420, the 5G-AN 422, the 5GC 424, the edge entity 430, and the alternate network 440, respectively, of FIG. 4. Similarities are not repeated herein.

In an example, the 5GC 524 can store a UE authorization 528 for sending edge-anchored indications to the UE 510. As such, during a PDU session establishment or modification and/or based on a request of the edge entity 530 or an AF, the 5GC 524 can determine the UE authorization 528 and send an edge-anchored indication 526 (similar to the edge-anchored indication 416 of FIG. 4) to the UE 510.

For example, a UDR of the 5GC 524 (e.g., the UDR 302 of FIG. 3) stores subscription data, such as session management (SM) subscription data, associated with the UE 510. This data can include an SM field that stores the UE authorization 528. As such, this data can explicitly indicate whether the UE 510 is authorized to receive edge-anchored indications from the 5GS 520 based on a subscription with the MNO. In the illustration of FIG. 5, the UE 510 is authorized and information in the SM field can indicate this authorization. Otherwise, information in the SM field (or a blank SM field) can indicate a lack of authorization. Additionally, or alternatively, the subscription data (e.g., the SM field) stores a UE authorization for discovery of edge application server (EAS) via an edge application server discovery function (EASDF). In this case, the UE authorization can serve as a dual purpose authorization: a first authorization edge-anchored indications and a second authorization for the discover of the EAS via the EASDF. In other words, the first authorization can be derived implicitly from the SM subscription data for the EAS via the EASDF.

An SMF of the 5GC 524 (e.g., the SMF 342 of FIG. 3) may retrieve or derive the UE authorization 528 for the edge-anchored indication 526 from the UDR at the time of the PDU session establishment or medication. In addition, the SMF can subscribe to notifications of the UDR about updates to the subscription data and can receive from the UDR an update indicating that this UE authorization 528 is now included in the subscription data or, conversely, is no longer included. Based on the UE authorization 528 and, possibly or optionally other information (e.g., policy information as described in the next figures), the SMF (or more generally the 5GS 520) can determine that the edge-anchored indication 526 is to be sent to the UE 510 and can do so.

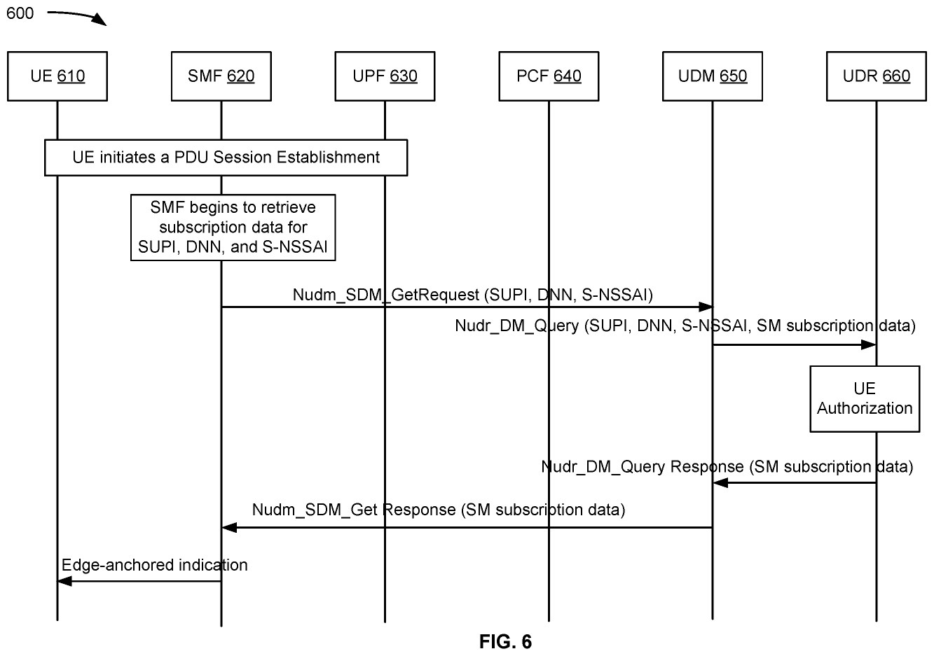

FIG. 6 illustrates an example of a sequence diagram 600 for UE authorization-based edge anchoring, in accordance with some embodiments. The sequence diagram 600 represents steps that different components can perform to send an edge-anchored indication to a UE 610 based on a UE authorization (which may be explicit or implicit). As illustrated in FIG. 6, in addition to the UE 610, these components include an SMF 620, a UPF 630, a PCF 640, a UDM 650, and a UDR 660 of a 5GC (e.g., of the 5GC 524 of FIG. 5).

Initially, the UE 610 initiates a PDU session establishment, where the SMF 620 and the UPF 630 can facilitate this establishing. At that time, the SMF 620 can bring retrieving subscription data for a subscriber permanent identifier (SUPI), a data network name (DNN), and a single network slice selection assistance information (S-NSSAI). For example, the SMF 620 makes a request to the UDM 650 using a Nudm interface (shown as a Nudm_SDM_GetRequest (SUPI, DNN, S-NSSAI)). In turn, the UDM 650 makes a call to the UDR 660 over an Nudr interface to request the subscription data (shown as Nudr_DM_Query (SUPI, DNN, S-NSSAI, SM subscription data)). The UDM 650 looks up the subscription data based on the SUPI, DNN, and/or S-NSSAI and determines a corresponding UE authorization (explicit or implicit). This UE authorization is sent back as part of the SM subscription data (shown as being sent in a response to the UDM 650: Nudr_DM_Query Response (SM subscription data)). The UDM 650 responds to the SMF 620 with the UE authorization and other subscription data (e.g., shown as Nudm_SDM_Get Response (SM subscription data)). The SMF 620 determines an explicit UE authorization for sending an edge-anchored indication to the UE 610 or derives an implicit UE authorization for sending the edge-anchored indication to the UE 610 based on an explicit UE authorization for EAS discovery via EASDF. The SMF 620 then sends the edge-anchored indication to the UE 610.

In an example, the UE authorization can be a new element “UE authorization for Edge-anchored indication” in the SM subscription data as defined in a technical specification, such as being added to table 5.2.3.3.1-1 of 3GPP TS 23.502, V17.5.0 (2022-07). Optionally, the UE authorization may also be implicitly indicated by the setting of “UE authorization for EAS discovery via EASDF,” where this existing element is defined in a technical specification, such as being added to table 5.2.3.3.1-1 of 3GPP TS 23.502, V17.5.0 (2022-07), and its interpretation can be modified in light of the present disclosure to derive an implicit “UE authorization for Edge-anchored indication.”

Although not illustrated in the sequence diagram 600, the UE authorization (implicit or explicit) can be updated over time, whereby the UE authorization can be added to the SM subscription data, if not already added, or whereby the UE authorization can be removed from the SM subscription data, if previously added. An update to the SM subscription data (addition or removal of the UE authorization) can be sent to the SMF 620, whereby the SMF 620 may subscribe to changes in SM subscription data and may be notified through a Nudm-SDM_Notification service primitive. Upon such a notification, the SMF 620 may send an update to the UE 610 (e.g., may send the edge-anchored indication if the UE authorization is added, or an indication to that the edge-anchored indication is to be used if the UE authorization is removed).

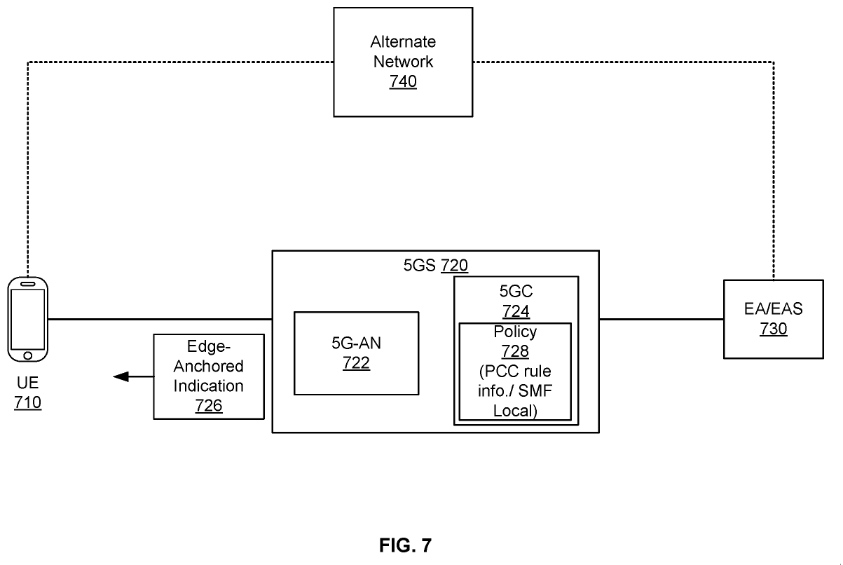

FIG. 7 illustrates an example of policy-based edge anchoring, in accordance with some embodiments. Generally, a policy can be stored and used to determine whether traffic to an edge entity is to be anchored or not. Because not all application traffic may require edge-anchoring, edge-anchored indications may only be provisioned if specific applications have been detected and the relevant policy or policies are in place to anchor traffic of an application to an edge hosting environment of the MNO.

In the illustration of FIG. 7, a UE 710 can communicate with an edge entity 730 (shown as an edge application function and/or an edge application server) via a 5GS 720 that includes a 5G-AN 722 and a 5GC 724 and that represents a 3GPP cellular network of an MNO. A PDU session can be established, whereby the 5GCS 720 can facilitate the traffic between the UE 710 and the edge entity 730. An alternate network 740 may also be available to the UE 710, where the traffic between the UE 710 and the edge entity 730 can be sent via the alternate network 740 instead of the 5GS 720 (e.g., by using another data session). The UE 710, the 5GS 720, the 5G-AN 722, the 5GC 724, the edge entity 730, and the alternate network 740 can be similar to the UE 410, the 5GS 420, the 5G-AN 422, the 5GC 424, the edge entity 430, and the alternate network 440, respectively, of FIG. 4. Similarities are not repeated herein.

In an example, the 5GC 724 can store a policy 728 for sending edge-anchored indications to the UE 710. The policy 728 can be associated with the edge entity 730, with an application or application type of the edge entity 730, and/or particular traffic or traffic type of the application. An association indicates that the policy 728 is to be applied to the traffic. As such, when the traffic in the PDU session begins or is being exchanged between the UE 710 and the edge component 730, the 5GC 724 (e.g., an SMF thereof) can determine whether the policy 728 applies to the traffic. In the illustration of FIG. 7, the determination is positive (e.g., the policy 728 applies) and, accordingly, the 5GC 724 sends an edge-anchored indication 726 to the UE 710.

In an example, the policy 728 can include policy information that can inform the SMF that the edge-anchored indication 726 is to be sent only if specific application traffic is detected. The policy information can be received as policy and charging control (PCC) rules from a PCF of the 5GC 724. For example, the policy 728 (e.g., the particular policy information) can be included in a new field of PCC rule information in the 5GC 524, as defined in a technical specification, such as 3GPP TS 23.503, V17.5.0 (2022-07). The new field can be an “Indication of Edge enabler usage,” which can indicate that the edge-anchored indication 726 is to be sent if any of the edge enablers like local PSA user plane function (UPF) or uplink (UL) classifier (CL) is used for the PDU session to access a local edge hosting environment (e.g., the edge entity 730). Such policy information can be included in a policy control section or an AF) influenced traffic steering enforcement control section of the PCC rule information. In another example, the policy 728 can be a local policy configured in the SMF (e.g., stored locally to the SMF).

Detecting whether the policy 728 applies to traffic can involve determining a match between the traffic and the policy information. For example, the policy information can include a service data flow (SDF) filter. The match can be between the traffic and the SDF filter. This type of match can be determined by a UPF of the 5GS 720.

Upon the SMF determining that the policy 728 applies, other checks can be performed before the SMF sends the edge-anchored indication 726 to the UE 710. For example, the SMF can determine whether a UE authorization exists, similarly to what is described herein above in connection with FIGS. 5 and 6. If the UE authorization also exists, then the edge-anchored indication 726 is sent.

As such, using the policy 728 can involve the following. Application traffic begins. The UPF detects that this traffic corresponds to the SDF associated with the policy 728. Next, the UPF informs the SMF of the traffic matching the SDF filter. In turn, the SMF checks UE authorization and the policy 728 (either dynamic PCC rules or local configuration) to decide if the UE 710 is to be provided with the edge-anchored indication 726.

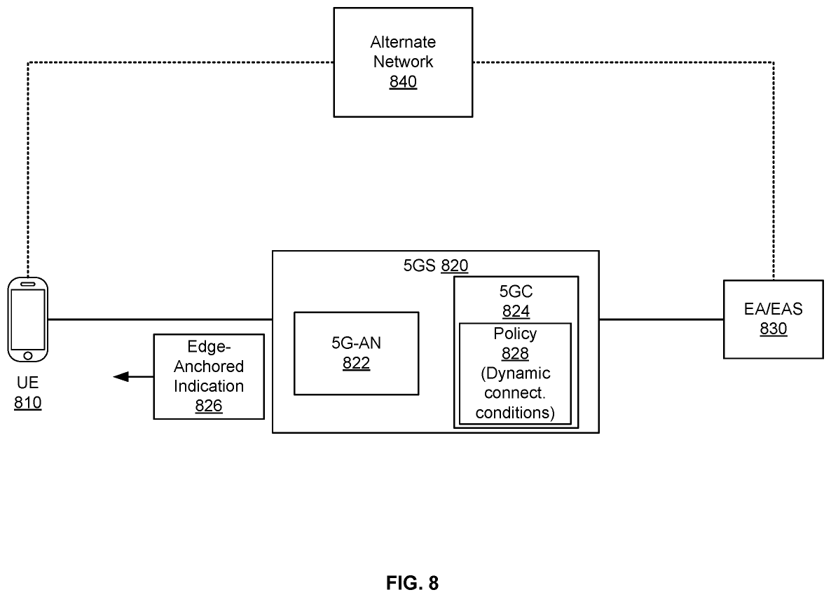

FIG. 8 illustrates an example of dynamic connection conditions-based edge anchoring, in accordance with some embodiments. Generally, one or more parameters of a UE connection with an edge entity via a network can dynamically change over time. For example, a UE connection with the edge entity via an alternate network can provide better performance (e.g., throughput, latency, quality of service (QoS), etc.). Conversely, the alternate UE connection's performance can deteriorate. In such situations, an AF can indicate to the network whether the traffic is to be edge-anchored or not. As such, depending on the connection conditions, the edge anchoring can be dynamically adjusted, whereby the network can send an edge-anchored indication to the UE indicating that the traffic (or the PDU session) is edge-anchored, as needed, or can send another indication to the UE that the traffic (or the PDU session) is no longer edge-anchored.

In the illustration of FIG. 8, a UE 810 can communicate with an edge entity 830 (shown as an edge application function and/or an edge application server) via a 5GS 820 that includes a 5G-AN 822 and a 5GC 824 and that represents a 3GPP cellular network of an MNO. A PDU session can be established, whereby the 5GCS 820 can facilitate the traffic between the UE 810 and the edge entity 830. An alternate network 840 may also be available to the UE 810, where the traffic between the UE 810 and the edge entity 830 can be sent via the alternate network 840 instead of the 5GS 820 (e.g., by using another data session). The UE 810, the 5GS 820, the 5G-AN 822, the 5GC 824, the edge entity 830, and the alternate network 840 can be similar to the UE 410, the 5GS 420, the 5G-AN 422, the 5GC 424, the edge entity 430, and the alternate network 440, respectively, of FIG. 4. Similarities are not repeated herein.

In an example, the 5GC 824 can store a policy 828 for sending edge-anchored indications to the UE 810. The policy 828 can be updated depending on traffic, application, network, and/or connections conditions, wherein the policy 828 can set switching restrictions or lifting such restrictions according to changes observed for the traffic and/or connectivity. The 5GC 824 (e.g., a NEF thereof) can update the policy 828 and the 5GC 824 (e.g., an SMF thereof) can look up policy information of the policy 828 to determine whether the edge-anchored indication 826 is to be sent to the UE 810 indicating that the traffic (or PDU session) is edge-anchored, or whether another indication is to be sent to the UE 810 to indicate that the traffic (or PDU session) is to no longer be edge-anchored. Of course, the 5GC 824 can performs other checks before sending any of such indications, such as also checking for a UE authorization and/or an application authorization as described in connection with FIGS. 5-7.

In an example, the policy 828 can provide different controls to an AF. For instance, an application service level does not require guaranteed QoS from the 5GS 820 and, hence, does not require traffic to be bound to the 5GS 820, and/or if the UE 810 has a better connection to another edge entity which is not visible to the 5GS 820. In such situations, the AF can indicate to the 5GS 820 to stop provisioning edge-anchored or 5GC preferred or 3GPP access preferred or any indication that causes application traffic to flow through the 5GS 820. The NEF service or “AFSessionWithQoS” can be enhanced (e.g., augmented) with additional fields that enable the AF to configure setting of traffic switching restrictions and lifting them according to the changes observed for the UE application traffic and connectivity.

The AF can provide the required setting in the Nnef_AFSessionWithQoS service API. In turn, the NEF authorizes the AF for this service action. If the AF is authorized for this service, the NEF forwards the setting to a PCF of the 5GC 824. The PCF determines whether an SM policy update is required and informs the SMF. The SMF initiates a PDU session modification and delivers the required setting as part of ePCO. The setting can take different values. One example value indicates whether the UE 810 should consider the PDU session connectivity as offering edge-enablers to access the edge component 830. Another example value indicates whether the UE 810 should prefer the 5GC connectivity for the application traffic (access can be 3GPP or non-3GPP). Yet another example value indicates whether the UE 810 should prefer 3GPP access connectivity for the application traffic. These and other functionalities are described in connection with the next figures.

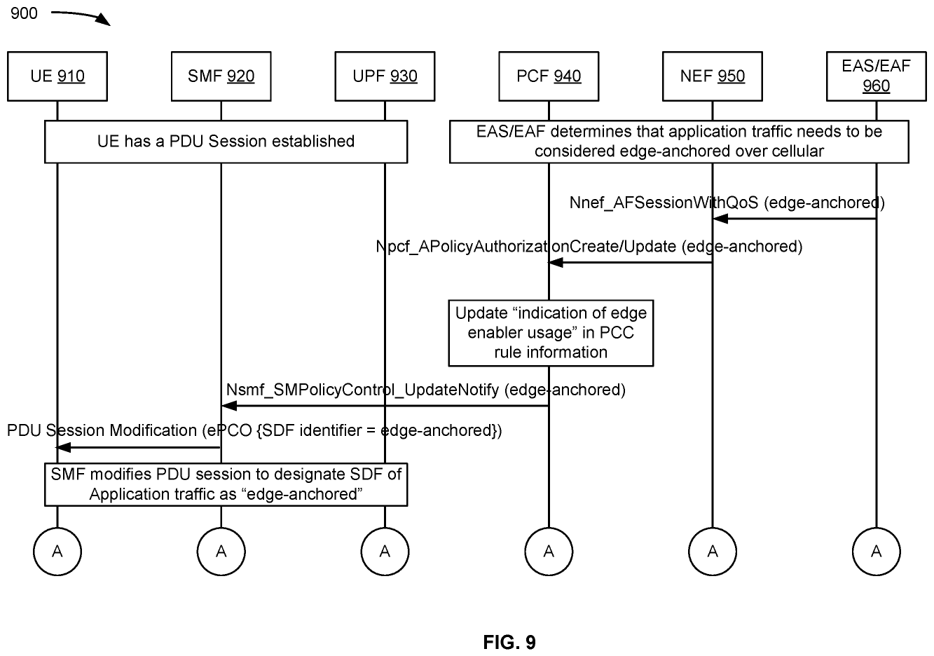

FIG. 9 illustrates an example of a sequence diagram 900 for dynamic connection conditions-based edge anchoring, in accordance with some embodiments. The sequence diagram 900 is applicable to sending an edge-anchored indication to a UE 910. The sequence diagram 900 represents steps that different components can perform to send the edge-anchored indication based on different conditions that may dynamically change over time. As illustrated in FIG. 9, in addition to the UE 910, these components include an SMF 920, a UPF 930, a PCF 940, a NEF 950, and an edge entity 960 (shown as an EAS and/or EAF).

Initially, the UE 910 has a PDU session that is already established. Based on this PDU session, application traffic can be communicated (e.g., sent and/or received) with the edge component 960 via a 5GS that includes the SMF 920, the UPF 930, the PCF 940, and the NEF 950. The edge component 960 determines that the application traffic needs to be considered edge-anchored over cellular. Accordingly, the edge component 960 (or an AF associated therewith) sends a request for edge-anchoring the application traffic. This request can be a “Nnef_AFSessionWithQoS (edge-anchored)” API call to the NEF 950, where the “edge-anchored” value in the call provides the indication. Optionally, the NEF 950 may request and receive information from the PCF 940 to determine if a policy is already existent and specifies the edge-anchoring. If so, no additional steps may be needed. Otherwise, the NEF 950 can proceed to update the policy as described in the next steps. Alternatively, and as illustrated in FIG. 9, the NEF 950 does not process the policy. Instead, the NEF 950 passes the request to the PCF 940 that then performs the processing. As illustrated in the next figures, before passing this request, the NEF 950 can determine whether the edge component 960 (or the AF) is authorized to request the edge anchoring. If authorized, the request is passed. Otherwise, the request is not passed, and no additional steps may be needed. Passing the request can include an API call to the PCF 940, such as a “Npcf_APolicyAuthorizationCreate/Update (edge-anchored)” call indicating the edge anchoring (e.g., “edge-anchored” is added as a value in this call).

Next, the PCF 940 updates the policy as needed. For example, the policy is updated only when no current indication for the edge anchoring is specified therein. In an example, the policy is stored as policy information in PCC rule information. In this case, an “indication of edge enabler usage” can be added to indicate that the application traffic is to be edge-anchored.

Upon the update, the PCF 940 can inform the SMF 920 about the edge anchoring of the application traffic. For example, an API call to the SMF 920 is made, such as a “Nsmf_SMPolicyControl_UpdateNotify (edge-anchored)” call indicating the edge anchoring (e.g., “edge-anchored” is added as a value in this call).

Upon receiving an indication that the application traffic is to be edge-anchored, the SMF 920 can send an edge-anchored indication to the UE 910. In this case, a PDU session modification message can be sent, illustrated as a “PDU Session Modification (ePCO {SDF identifier=edge-anchored})”, wherein the ePCO information indicates the edge anchoring. The SMF 920 can then modify the PDU session to designate an SDF of the application traffic as being “edge-anchored.”

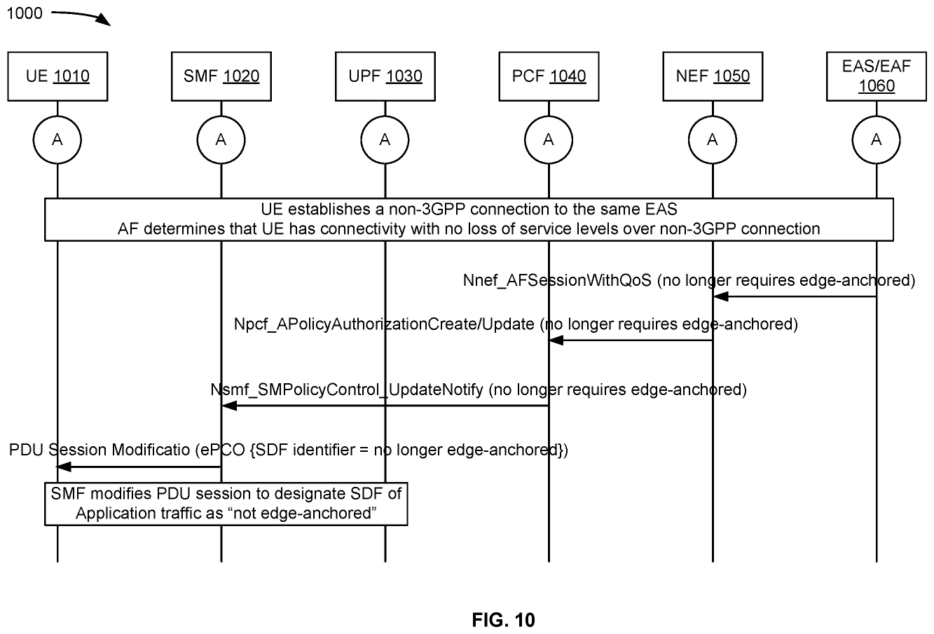

FIG. 10 illustrates another example of a sequence diagram 100 for dynamic connection conditions-based edge anchoring, in accordance with some embodiments. The sequence diagram 1000 is applicable to informing a UE 1010 that an edge-anchored indication is no longer usable or applicable. As illustrated with the bubbles labeled with the letter “A,” the sequence diagram 1000 can be performed following the sequence diagram 900 of FIG. 9. Nonetheless, the sequence diagram 1000 can be independently performed of the sequence diagram 900 whenever the edge-anchored indication is no longer usable or applicable. Additionally or alternatively, the sequence diagram 900 can be performed after the sequence diagram 1000 when the edge-anchored indication becomes usable or applicable.

As illustrated in FIG. 10, the sequence diagram 1000 represents steps that different components can perform to send the edge-anchored indication based on different conditions that may dynamically change over time. As illustrated in FIG. 10, in addition to the UE 1010, these components include an SMF 1020, a UPF 1030, a PCF 1040, a NEF 1050, and an edge entity 1060 (shown as an EAS and/or EAF).

Initially, the UE 1010 established a connection to the same edge entity described in the sequence diagram 900 (e.g., the edge entity 1060 is the same as the edge entity 960) using an alternate network (e.g., a non-3GPP network, where the connection would be a non-3GPP connection). The AF associated with the edge entity 1050 determines that the UE 1010 has connectivity with no loss of service levels over this connection. The AF can then send a request to the NEF 1050 to indicate that the application traffic no longer requires to be edge-anchored. This request can be a “Nnef_AFSessionWithQoS (no longer requires edge-anchored)” API call to the NEF 1050, where the “no longer requires edge-anchored” value in the call provides the indication. Optionally, the NEF 1050 may request and receive information from the PCF 1040 to determine if a policy is already existent and specifies that the edge-anchoring is not needed. If so, no additional steps may be needed. Otherwise, the NEF 1050 can proceed to update the policy as described in the next steps. Alternatively, and as illustrated in FIG. 10, the NEF 1050 does not process the policy. Instead, the NEF 1050 passes the request to the PCF 1040 that then performs the processing. As further illustrated herein below, before passing this request, the NEF 1050 can determine whether the AF is authorized to request the lifting of the edge anchoring. If authorized, the request is passed. Otherwise, the request is not passed, and no additional steps may be needed. Passing the request can include an API call to the PCF 1040, such as a “Npcf_APolicyAuthorizationCreate/Update (no longer requires edge-anchored)” call indicating that edge anchoring is no longer needed (e.g., “no longer requires edge-anchored” is added as a value in this call).

Next, the PCF 1040 updates the policy as needed. For example, the policy is updated only when no current indication for no edge anchoring is specified therein. In an example, the policy is stored as policy information in PCC rule information. In this case, an “indication of edge enabler usage” can be removed to indicate that the application traffic is to no longer be edge-anchored. Upon the update, the PCF 1040 can inform the SMF 1020 about the lifting of the edge anchoring for the application traffic. For example, an API call to the SMF 1020 is made, such as a “Nsmf_SMPolicyControl_UpdateNotify (no longer requires edge-anchored)” call indicating that the edge anchoring is no longer needed (e.g., “no longer requires edge-anchored” is added as a value in this call).

Upon receiving an indication that the application traffic is to no longer be edge-anchored, the SMF 1020 can send an indication to the UE 1010 that the application traffic need no longer be edge anchored. In this case, a PDU session modification message can be sent, illustrated as a “PDU Session Modification (ePCO {SDF identifier=no longer edge-anchored})”, wherein the ePCO information indicates that the edge anchoring is no longer needed. The SMF 1020 can then modify the PDU session to designate an SDF of the application traffic as being “not edge-anchored.”

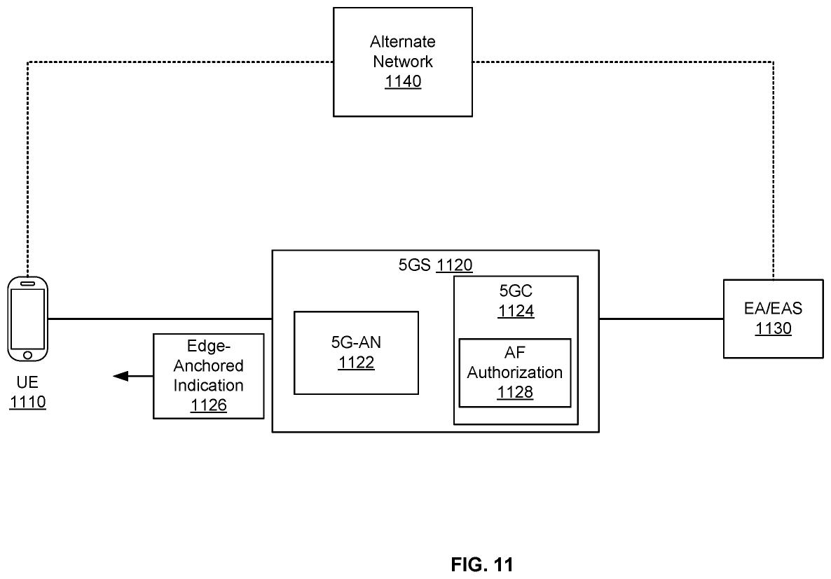

FIG. 11 illustrates an example of AF authorization-based edge anchoring, in accordance with some embodiments. As described herein above, AFs can request the change to the edge anchoring of traffic. To prevent misuse of edge-anchored indications, an AF that requests setting of traffic switching indications can be authorized by a 5GS (e.g., a NEF thereof). If authorized, a request to edge-anchor the traffic or to longer edge-anchor the traffic can be processed. Otherwise, the request can be denied. For example, when the NEF receives the request from the AF, the NEF checks whether the AF is authorized for the operation setting requested by the AF (e.g., set “edge-anchored” or as “no longer requires edge-anchored”). The NEF can store and maintain information that identifies AFs and the authorization of each of such AFs vis-à-vis the edge anchoring. This information can be looked up to determine the authorization.

In the illustration of FIG. 11, a UE 1110 can communicate with an edge entity 1130 (shown as an edge application function and/or an edge application server) via a 5GS 1120 that includes a 5G-AN 1122 and a 5GC 1124 and that represents a 3GPP cellular network of an MNO. A PDU session can be established, whereby the 5GCS 1120 can facilitate the traffic between the UE 1110 and the edge entity 1130. An alternate network 1140 may also be available to the UE 1110, where the traffic between the UE 1110 and the edge entity 1130 can be sent via the alternate network 1140 instead of the 5GS 1120 (e.g., by using another data session). The UE 1110, the 5GS 1120, the 5G-AN 1122, the 5GC 1124, the edge entity 1130, and the alternate network 1140 can be similar to the UE 410, the 5GS 420, the 5G-AN 422, the 5GC 424, the edge entity 430, and the alternate network 440, respectively, of FIG. 4. Similarities are not repeated herein.

In an example, the 5GC 1124 (e.g., a NEF thereof) can store an AF authorization 1128 for requesting changes to edge-anchored indications for all UEs, for a particular set of UEs, or for the specific UE 1110. The AF authorization 1128 can be associated with an AF identifier and can indicate (e.g., using a Boolean value or any other types of value) whether the AF having the AF identifier is authorized to set traffic to be edge-anchored, to no longer be edge-anchored, and/or to request both types of settings. In addition to possibly be granular to the UE level, the AF authorization 1128 can be global to all traffic of the AF or granular to particular type of traffic of the AF.

As such, the 5GC 1124 (e.g., the NEF) can receive a request of the AF associated with the edge entity 1130 requesting a change to the edge anchoring of application traffic (e.g., to edge-anchor it or to no longer edge-anchor it). The 5GC 1124 (e.g., the NEF) can look up the AF authorization 1128 to determine whether the AF is authorized to make this change. If the determination is positive (as illustrated in FIG. 11), the 5GC 1124 can further process the request (e.g., as illustrated in FIGS. 10 and 11) to then generate and send an edge-anchored indication 1126 to the UE 1110. Otherwise, no such edge-anchored indication 1126 is sent.

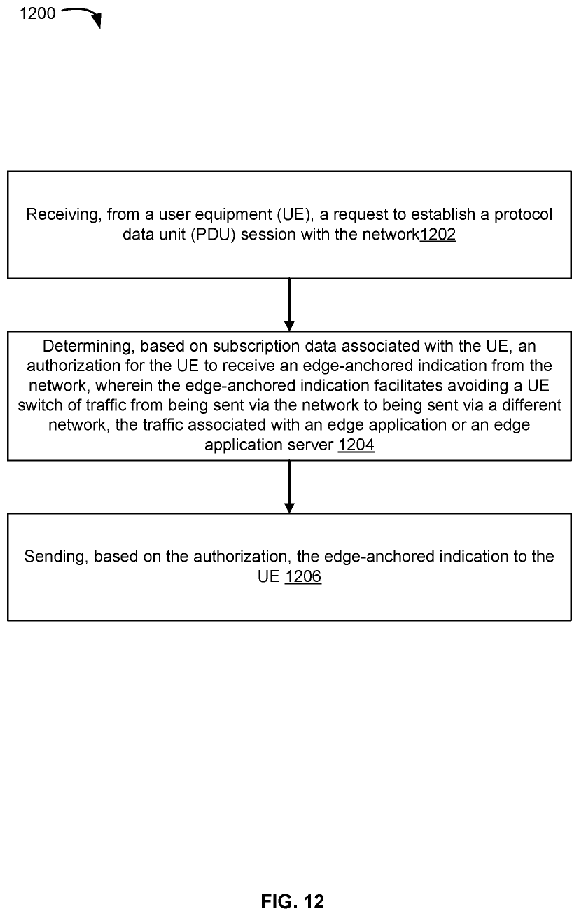

FIG. 12 illustrates an example of an operational flow/algorithmic structure 1200 for edge anchoring of UE communications, in accordance with some embodiments. The operational flow/algorithmic structure 1200 can be implemented by a network, such as one including any of the 5GS's described herein above. In particular, the operational flow/algorithmic structure 1200 can be implemented as instructions stored in one or more memory of a system (e.g., a 5GS) that, upon execution by one or more processors of the system, configure the system to perform the operations of the operational flow/algorithmic structure 1200.

In an example, the operational flow/algorithmic structure 1200 includes, at 1202, receiving, from a UE, a request to establish a PDU session with the network. This request can be received by a 5GC of the network (e.g., via a base station of a 5G-AN of the network) and processed by the 5GC (e.g., by an SMF and UPF) to establish the PDU session, such that traffic between the UE and an edge entity can be facilitated via the network based on the PDU session.

In an example, the operational flow/algorithmic structure 1200 includes, at 1204, determining, based on subscription data associated with the UE, an authorization for the UE to receive an edge-anchored indication from the network, wherein the edge-anchored indication facilitates avoiding a UE switch of traffic from being sent via the network to being sent via a different network, the traffic associated with an edge application or an edge application server. For instance, the edge entity includes the edge application or the edge application server. The subscription data can explicitly or implicitly indicate the authorization. The subscription data can be stored by a UDR of the 5GC and the authorization can be requested and retrieved therefrom by the SMF.

In an example, the operational flow/algorithmic structure 1200 includes, at 1206, sending, based on the authorization, the edge-anchored indication to the UE. For instance, the edge-anchored indication is sent using URSP RSD fields or using ePCO IEs. As described herein above, in addition to checking the UE authorization based on subscription data, a policy applicable to the traffic and/or AF associated with the edge entity can also be checked to determine whether the edge-anchored indication is to be sent to the UE.

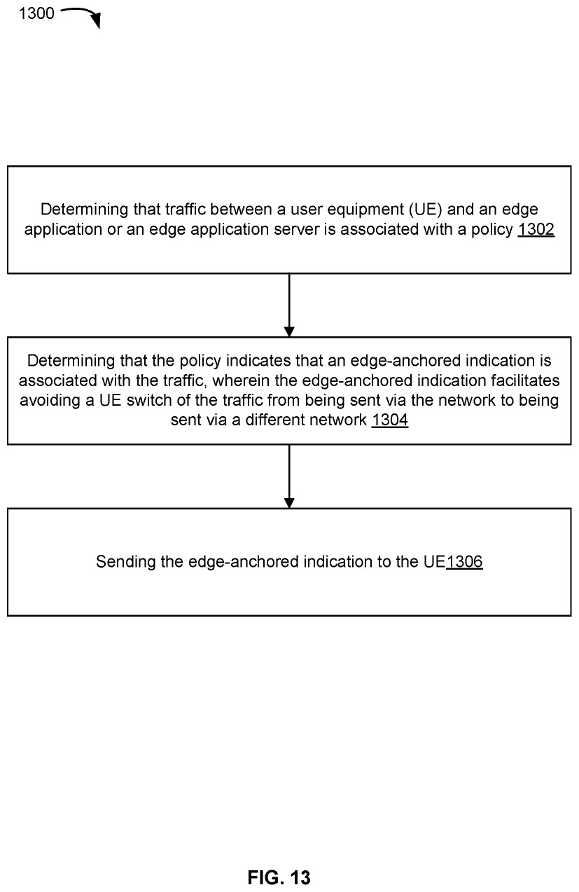

FIG. 13 illustrates an example of an operational flow/algorithmic structure for edge anchoring of UE communications, in accordance with some embodiments. The operational flow/algorithmic structure 1300 can be implemented by a network, such as one including any of the 5GS's described herein above. In particular, the operational flow/algorithmic structure 1300 can be implemented as instructions stored in one or more memory of a system (e.g., a 5GS) that, upon execution by one or more processors of the system, configure the system to perform the operations of the operational flow/algorithmic structure 1300.

In an example, the operational flow/algorithmic structure 1300 includes, at 1302, determining that traffic between a UE and an edge application or an edge application server is associated with a policy. The traffic can be facilitated based on a PDU session established via the network (e.g., a 5GC of the network). A UPF of the 5GC can detect that the traffic corresponds to an SDF and can inform an SMF of the 5GC of this detection.

In an example, the operational flow/algorithmic structure 1300 includes, at 1304, determining that the policy indicates that an edge-anchored indication is associated with the traffic, wherein the edge-anchored indication facilitates avoiding a UE switch of the traffic from being sent via the network to being sent via a different network. For instance, the SMF can determine that the policy applies to the SDF and can determine the AF authorization to from policy information of the policy.

In an example, the operational flow/algorithmic structure 1300 includes, at 1306, sending the edge-anchored indication to the UE. For instance, the edge-anchored indication is sent using URSP RSD fields or using ePCO IEs. As described herein above, in addition to checking the AF authorization based on policy information, a UE authorization can also be checked to determine whether the edge-anchored indication is to be sent to the UE.

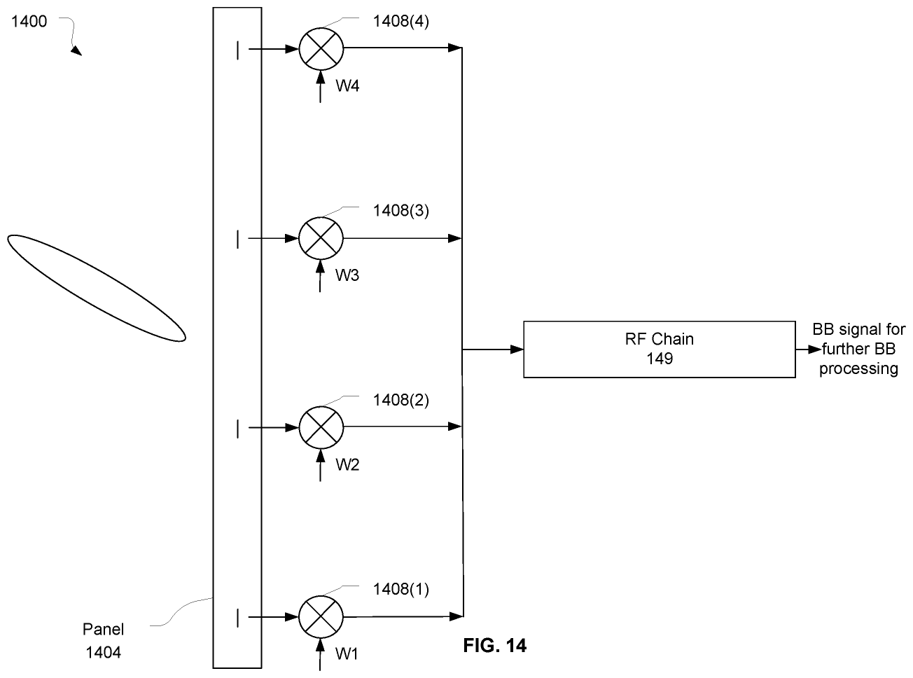

FIG. 14 illustrates receive components 1400 of the UE 106, in accordance with some embodiments. The receive components 1400 may include an antenna panel 1404 that includes a number of antenna elements. The panel 1404 is shown with four antenna elements, but other embodiments may include other numbers.

The antenna panel 1404 may be coupled to analog beamforming (BF) components that include a number of phase shifters 1408(1)-1408(4). The phase shifters 1408(1)-1408(4) may be coupled with a radio-frequency (RF) chain 1412. The RF chain 1412 may amplify a receive analog RF signal, downconvert the RF signal to baseband, and convert the analog baseband signal to a digital baseband signal that may be provided to a baseband processor for further processing.

In various embodiments, control circuitry, which may reside in a baseband processor, may provide BF weights (for example W1-W4), which may represent phase shift values, to the phase shifters 1408(1)-1408(4) to provide a receive beam at the antenna panel 1404. These BF weights may be determined based on the channel-based beamforming.

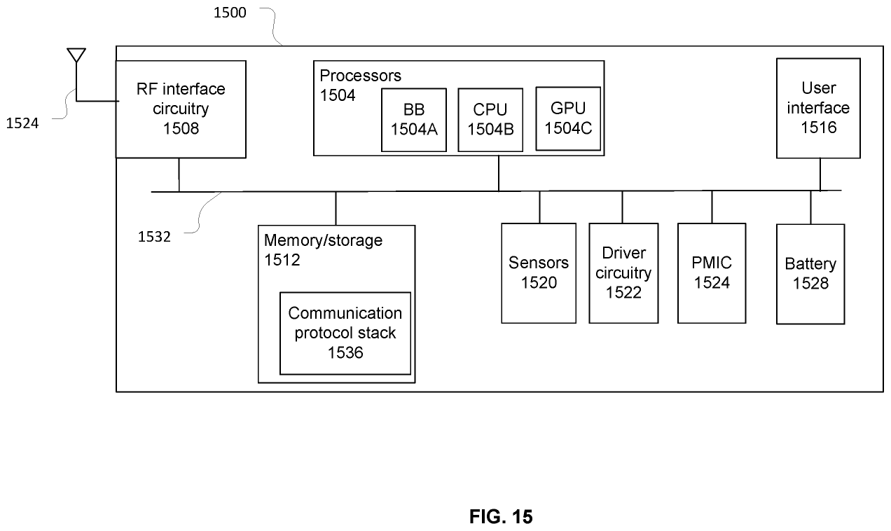

FIG. 15 illustrates a ULE 1500, in accordance with some embodiments. The UE 1500 may be similar to and substantially interchangeable with UE 106 of FIG. 1.

Similar to that described above with respect to UE 154, the UE 1500 may be any mobile or non-mobile computing device, such as mobile phones, computers, tablets, industrial wireless sensors (for example, microphones, carbon dioxide sensors, pressure sensors, humidity sensors, thermometers, motion sensors, accelerometers, laser scanners, fluid level sensors, inventory sensors, electric voltage/current meters, actuators, etc.), video surveillance/monitoring devices (for example, cameras, video cameras, etc.), wearable devices, or relaxed-IoT devices. In some embodiments, the UE may be a reduced capacity UE or NR-Light UE.

The UE 1500 may include processors 1504, RF interface circuitry 1508, memory/storage 1512, user interface 1516, sensors 1520, driver circuitry 1522, power management integrated circuit (PMIC) 1524, and battery 1528. The components of the UE 1500 may be implemented as integrated circuits (ICs), portions thereof, discrete electronic devices, or other modules, logic, hardware, software, firmware, or a combination thereof. The block diagram of FIG. 15 is intended to show a high-level view of some of the components of the UE 1500. However, some of the components shown may be omitted, additional components may be present, and different arrangements of the components shown may occur in other implementations.

The components of the UE 1500 may be coupled with various other components over one or more interconnects 1532, which may represent any type of interface, input/output, bus (local, system, or expansion), transmission line, trace, optical connection, etc. that allows various circuit components (on common or different chips or chipsets) to interact with one another.

The processors 1504 may include processor circuitry such as baseband processor circuitry (BB) 1504A, central processor unit circuitry (CPU) 1504B, and graphics processor unit circuitry (GPU) 1504C. The processors 1504 may include any type of circuitry or processor circuitry that executes or otherwise operates computer-executable instructions, such as program code, software modules, or functional processes from memory/storage 1512 to cause the UE 1500 to perform operations as described herein.

In some embodiments, the baseband processor circuitry 1504A may access a communication protocol stack 1536 in the memory/storage 1512 to communicate over a 3GPP compatible network. In general, the baseband processor circuitry 1504A may access the communication protocol stack to: perform user plane functions at a PHY layer, MAC layer, RLC layer, PDCP layer, SDAP layer, and PDU layer; and perform control plane functions at a PHY layer, MAC layer, RLC layer, PDCP layer, RRC layer, and a non-access stratum “NAS” layer. In some embodiments, the PHY layer operations may additionally/alternatively be performed by the components of the RF interface circuitry 1508.

The baseband processor circuitry 1504A may generate or process baseband signals or waveforms that carry information in 3GPP-compatible networks. In some embodiments, the waveforms for NR may be based on cyclic prefix OFDM (CP-OFDM) in the uplink or downlink, and discrete Fourier transform spread OFDM (DFT-S-OFDM) in the uplink.

The baseband processor circuitry 1504A may also access group information 1524 from memory/storage 1512 to determine search space groups in which a number of repetitions of a PDCCH may be transmitted.

The memory/storage 1512 may include any type of volatile or non-volatile memory that may be distributed throughout the UE 1500. In some embodiments, some of the memory/storage 1512 may be located on the processors 1504 themselves (for example, L1 and L2 cache), while other memory/storage 1512 is external to the processors 1504 but accessible thereto via a memory interface. The memory/storage 1512 may include any suitable volatile or non-volatile memory, such as, but not limited to, dynamic random-access memory (DRAM), static random-access memory (SRAM), erasable programmable read-only memory (EPROM), electrically erasable programmable read-only memory (EEPROM), Flash memory, solid-state memory, or any other type of memory device technology.

The RF interface circuitry 1508 may include transceiver circuitry and a radio frequency front module (RFEM) that allows the UE 1500 to communicate with other devices over a radio access network. The RF interface circuitry 1508 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via an antenna 1524 and proceed to filter and amplify (with a low-noise amplifier) the signal. The signal may be provided to a receiver of the transceiver that down-converts the RF signal into a baseband signal that is provided to the baseband processor of the processors 1504.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 1524.

In various embodiments, the RF interface circuitry 1508 may be configured to transmit/receive signals in a manner compatible with NR access technologies.

The antenna 1524 may include a number of antenna elements that each convert electrical signals into radio waves to travel through the air and to convert received radio waves into electrical signals. The antenna elements may be arranged into one or more antenna panels. The antenna 1524 may have antenna panels that are omnidirectional, directional, or a combination thereof to enable beamforming and multiple input, multiple output communications. The antenna 1524 may include microstrip antennas, printed antennas fabricated on the surface of one or more printed circuit boards, patch antennas, phased array antennas, etc. The antenna 1524 may have one or more panels designed for specific frequency bands including bands in FR1 or FR2.

The user interface circuitry 1516 includes various input/output (I/O) devices designed to enable user interaction with the ULE 1500. The user interface 1516 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators, such as light emitting diodes (LEDs) and multi-character visual outputs, or more complex outputs, such as display devices or touchscreens (for example, liquid crystal displays (LCDs), LED displays, quantum dot displays, projectors, etc.), with the output of characters, graphics, multimedia objects, and the like being generated or produced from the operation of the UE 1500.

The sensors 1520 may include devices, modules, or subsystems whose purpose is to detect events or changes in its environment and send the information (sensor data) about the detected events to some other device, module, subsystem, etc. Examples of such sensors include, inter alia, inertia measurement units comprising accelerometers; gyroscopes; or magnetometers; microelectromechanical systems or nanoelectromechanical systems comprising 3-axis accelerometers; 3-axis gyroscopes; or magnetometers; level sensors; flow sensors; temperature sensors (for example, thermistors); pressure sensors; barometric pressure sensors; gravimeters; altimeters; image capture devices (for example; cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 1522 may include software and hardware elements that operate to control particular devices that are embedded in the UE 1500, attached to the UE 1500, or otherwise communicatively coupled with the UE 1500. The driver circuitry 1522 may include individual drivers allowing other components to interact with or control various input/output (I/O) devices that may be present within, or connected to, the UE 1500. For example, driver circuitry 1522 may include a display driver to control and allow access to a display device, a touchscreen driver to control and allow access to a touchscreen interface, sensor drivers to obtain sensor readings of sensor circuitry 1520 and control and allow access to sensor circuitry 1520, drivers to obtain actuator positions of electro-mechanic components or control and allow access to the electro-mechanic components, a camera driver to control and allow access to an embedded image capture device, audio drivers to control and allow access to one or more audio devices.

The PMIC 1524 may manage power provided to various components of the UE 1500. In particular, with respect to the processors 1504, the PMIC 1524 may control power-source selection, voltage scaling, battery charging, or DC-to-DC conversion.

In some embodiments, the PMIC 1524 may control, or otherwise be part of, various power saving mechanisms of the UE 1500. For example, if the platform UE is in an RRC_Connected state, where it is still connected to the RAN node as it expects to receive traffic shortly, then it may enter a state known as Discontinuous Reception Mode (DRX) after a period of inactivity. During this state, the UE 1500 may power down for brief intervals of time and thus save power. If there is no data traffic activity for an extended period of time, then the UE 1500 may transition off to an RRC_Idle state, where it disconnects from the network and does not perform operations, such as channel quality feedback, handover, etc. The UE 1500 goes into a very low power state and it performs paging where again it periodically wakes up to listen to the network and then powers down again. The UE 1500 may not receive data in this state; in order to receive data, it must transition back to RRC_Connected state. An additional power saving mode may allow a device to be unavailable to the network for periods longer than a paging interval (ranging from seconds to a few hours). During this time, the device is totally unreachable to the network and may power down completely. Any data sent during this time incurs a large delay and it is assumed the delay is acceptable.

A battery 1528 may power the UE 1500, although in some examples the UE 1500 may be mounted deployed in a fixed location, and may have a power supply coupled to an electrical grid. The battery 1528 may be a lithium ion battery, a metal-air battery, such as a zinc-air battery, an aluminum-air battery, a lithium-air battery, and the like. In some implementations, such as in vehicle-based applications, the battery 1528 may be a typical lead-acid automotive battery.

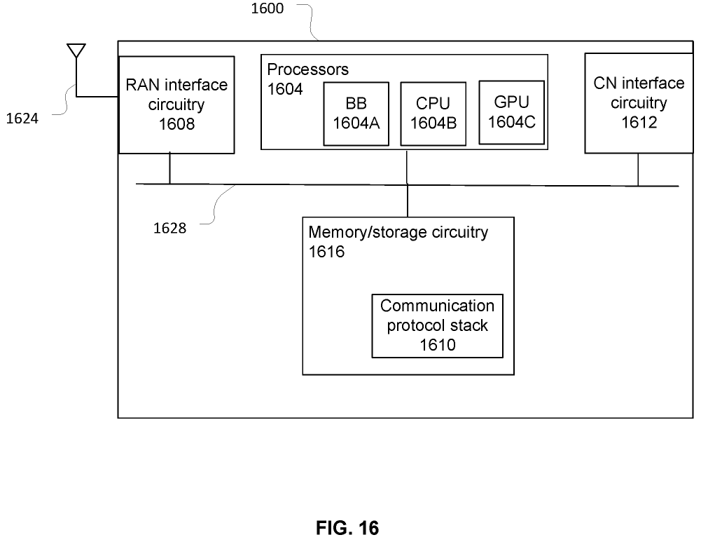

FIG. 16 illustrates a gNB 1600, in accordance with some embodiments. The gNB node 1600 may be similar to and substantially interchangeable with the base station 104 of FIG. 1.

The gNB 1600 may include processors 1604, RF interface circuitry 1608, core network (CN) interface circuitry 1612, and memory/storage circuitry 1616.

The components of the gNB 1600 may be coupled with various other components over one or more interconnects 1628.

The processors 1604, RF interface circuitry 1608, memory/storage circuitry 1616 (including communication protocol stack 1610), antenna 1624, and interconnects 1628 may be similar to like-named elements shown and described with respect to FIG. 13.

The CN interface circuitry 1612 may provide connectivity to a core network, for example, a 5^{th} Generation Core network (5GC) using a 5GC-compatible network interface protocol, such as carrier Ethernet protocols, or some other suitable protocol. Network connectivity may be provided to/from the gNB 1600 via a fiber optic or wireless backhaul. The CN interface circuitry 1612 may include one or more dedicated processors or FPGAs to communicate using one or more of the aforementioned protocols. In some implementations, the CN interface circuitry 1612 may include multiple controllers to provide connectivity to other networks using the same or different protocols.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### EXAMPLES

In the following sections, further exemplary embodiments are provided.

Example 1 includes a method implemented by a network, the method comprising: receiving, from a user equipment (UE), a request to establish a protocol data unit (PDU) session with the network; determining, based on subscription data associated with the UE, an authorization for the UE to receive an edge-anchored indication from the network, wherein the edge-anchored indication facilitates avoiding a UE switch of traffic from being sent via the network to being sent via a different network, the traffic associated with an edge application or an edge application server; and sending, based on the authorization, the edge-anchored indication to the UE.

Example 2 includes the method of example 1, wherein the authorization is determined from a session management (SM) field of the subscription data, wherein the SM field stores the authorization.

Example 3 includes the method of example 1, wherein the authorization is a first authorization that is determined from a session management (SM) field of the subscription data, wherein the SM field stores a UE authorization for discovery of edge application server (EAS) via an edge application server discovery function (EASDF), wherein the UE authorization indicates the first authorization and further indicates a second authorization for the discover of the EAS via the EASDF.

Example 4 includes the method of any example 1 through 3, wherein the authorization is determined as part of establishing the PDU session.

Example 5 includes the method of any example 1 through 4, further comprising: receiving a notification about an update to the subscription data, the update indicating that the authorization is included in the subscription data.

Example 6 includes the method of any example 1 through 5, further comprising: determining that the traffic is associated with a policy; and determining that the policy indicates that the edge-anchored indication is associated with the traffic, wherein sending the edge-anchored indication to the UE is further based on the policy.

Example 7 includes the method of example 6, wherein the policy is determined from policy and charging control (PCC) rule information.

Example 8 includes the method of example 7, wherein the PCC rule information includes an indication of using an edge enabler for the PDU session, wherein the determining that the policy indicates that the edge-anchored indication is associated with the traffic is based on the indication.

Example 9 includes the of example 8, wherein the indication is included in a policy control section or an application function (AF) influenced traffic steering enforcement control section of the PCC rule information.

Example 10 includes the method of example 6, wherein the policy is stored locally to a session management function (SMF) of the network.

Example 11 includes the method of example 6, wherein the policy associates the edge-anchored indication with the traffic by at least using a service data flow (SDF) filter.

Example 12 includes the method of example 11, further comprising: determining a match between the traffic and the SDF filter; and determining that the policy is applicable based on the match, wherein the authorization is determined based on the policy being applicable.

Example 13 includes the method of example 6, wherein the policy is determined from policy and charging control (PCC) rule information, and wherein the method further comprises: receiving a first request of the edge application or the edge application server indicating that the traffic is to be edge-anchored; and updating, based on the first request, the PCC rule information by at least updating the policy to indicate that the edge-anchored indication is associated with the traffic.

Example 14 includes the method of example 13, further comprising: receiving a second request of the edge application or the edge application server indicating that the traffic is to no longer be edge-anchored; and updating, based on the second request, the PCC rule information by at least updating the policy to indicate that the traffic is no longer edge-anchored.

Example 15 includes the method of example 13, further comprising: verifying that the first request is received from an application function (AF) authorized to indicate that the traffic is to be edge-anchored.

Example 16 includes a method implemented by a network, the method comprising: determining that traffic between a user equipment (UE) and an edge application or an edge application server is associated with a policy; determining that the policy indicates that an edge-anchored indication is associated with the traffic, wherein the edge-anchored indication facilitates avoiding a UE switch of the traffic from being sent via the network to being sent via a different network; and sending the edge-anchored indication to the UE.

Example 17 includes the method of example 16, further comprising: determining, based on subscription data associated with the UE, an authorization for the edge-anchored indication, wherein sending the edge-anchored indication to the UE is further based on the authorization.

Example 18 includes the method of example 17, wherein the authorization is determined from a session management (SM) field of the subscription data, wherein the SM field stores the authorization.

Example 19 includes the method of example 17, wherein the authorization is a first authorization that is determined from a session management (SM) field of the subscription data, wherein the SM field stores a UE authorization for discovery of edge application server (EAS) via an edge application server discovery function (EASDF), wherein the UE authorization indicates the first authorization and further indicates a second authorization for the discovery of the EAS via the EASDF.

Example 20 includes the method of example 17, wherein the authorization is determined as part of establishing a protocol data unit (PDU) session between the UE and the network.

Example 21 includes the method of any example 16 through 20, wherein the policy is determined from policy and charging control (PCC) rule information that includes an indication of using an edge enabler for a protocol data unit (PDU) session, wherein the determining that the policy indicates that the edge-anchored indication is associated with the traffic is based on the indication.

Example 22 includes the method of claim 21, wherein the indication is included in a policy control section or an application function (AF) influenced traffic steering enforcement control section of the PCC rule information.

Example 23 includes the method of any example 16 through 22, wherein the policy is stored locally to a session management function (SMF) of the network.

Example 24 includes the method of any example 16 through 23, wherein the policy associates the edge-anchored indication with the traffic by at least using a service data flow (SDF) filter.

Example 25 includes the method of claim 24, further comprising: determining a match between the traffic and the SDF filter; determining that the policy is applicable based on the match; and determining, from subscription data associated with the UE and based on the policy being applicable, an authorization for the edge-anchored indication, wherein sending the edge-anchored indication to the UE is further based on the authorization.

Example 26 includes the method of any example 16 through 25, wherein the policy is determined from policy and charging control (PCC) rule information, and wherein the method further comprises: receiving a first request of the edge application or the edge application server indicating that the traffic is to be edge-anchored; and updating, based on the first request, the PCC rule information by at least updating the policy to indicate that the edge-anchored indication is associated with the traffic.

Example 27 includes the method of claim 26, further comprising: receiving a second request of the edge application or the edge application server indicating that the traffic is to no longer be edge-anchored; and updating, based on the second request, the PCC rule information by at least updating the policy to indicate that the traffic is no longer edge-anchored.

Example 28 includes the method of claim 26, further comprising: verifying that the first request is received from an application function (AF) authorized to indicate that the traffic is to be edge-anchored.

Example 29 includes a network comprising means to perform one or more elements of a method described in or related to any of the examples 1-28.

Example 30 includes one or more non-transitory computer-readable media comprising instructions to cause a network, upon execution of the instructions by one or more processors of the network, to perform one or more elements of a method described in or related to any of the examples 1-28.

Example 31 includes a network comprising logic, modules, or circuitry to perform one or more elements of a method described in or related to any of the examples 1-28.

Example 32 includes a network comprising: one or more processors and one or more computer-readable media comprising instructions that, when executed by the one or more processors, cause the one or more processors to perform one or more elements of a method described in or related to any of the examples 1-28.

Example 33 includes a system comprising means to perform one or more elements of a method described in or related to any of the examples 1-28.

Any of the above-described examples may be combined with any other example (or combination of examples), unless explicitly stated otherwise. The foregoing description of one or more implementations provides illustration and description but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

Applicant hereby claims:

1. A method implemented by a network, the method comprising:
receiving, from a user equipment (UE), a request to establish a protocol data unit (PDU) session with the network;
determining, based on subscription data associated with the UE, an authorization for the UE to receive an edge-anchored indication from the network, wherein the edge-anchored indication facilitates avoiding a UE switch of traffic from being sent via the network to being sent via a different network, the traffic associated with an edge application or an edge application server; and
sending, based on the authorization, the edge-anchored indication to the UE.

2. The method of claim 1, wherein the authorization is determined from a session management (SM) field of the subscription data, wherein the SM field stores the authorization.

3. The method of claim 1, wherein the authorization is a first authorization that is determined from a session management (SM) field of the subscription data, wherein the SM field stores a UE authorization for discovery of edge application server (EAS) via an edge application server discovery function (EASDF), wherein the UE authorization indicates the first authorization and further indicates a second authorization for the discovery of the EAS via the EASDF.

4. The method of claim 1, wherein the authorization is determined as part of establishing the PDU session.

5. The method of claim 1, further comprising:
receiving a notification about an update to the subscription data, the update indicating that the authorization is included in the subscription data.

6. The method of claim 1, further comprising:
determining that the traffic is associated with a policy; and
determining that the policy indicates that the edge-anchored indication is associated with the traffic, wherein sending the edge-anchored indication to the UE is further based on the policy.

7. A system of a network, the system comprising:
one or more processors; and
one or more memory storing instructions that, upon execution by the one or more processors, configure the system to:
determine that traffic between a user equipment (UE) and an edge application or an edge application server is associated with a policy;
determine that the policy indicates that an edge-anchored indication is associated with the traffic, wherein the edge-anchored indication facilitates avoiding a UE switch of the traffic from being sent via the network to being sent via a different network; and
send the edge-anchored indication to the UE.

8. The system of claim 7, wherein the one or more memory store further instructions that, upon execution by the one or more processors, configure the system to:
determine, based on subscription data associated with the UE, an authorization for the edge-anchored indication, wherein sending the edge-anchored indication to the UE is further based on the authorization.

9. The system of claim 8, wherein the authorization is determined from a session management (SM) field of the subscription data, wherein the SM field stores the authorization.

10. The system of claim 8, wherein the authorization is a first authorization that is determined from a session management (SM) field of the subscription data, wherein the SM field stores a UE authorization for discovery of edge application server (EAS) via an edge application server discovery function (EASDF), wherein the UE authorization indicates the first authorization and further indicates a second authorization for the discovery of the EAS via the EASDF.

11. The system of claim 8, wherein the authorization is determined as part of establishing a protocol data unit (PDU) session between the UE and the network.

12. The system of claim 7, wherein the policy is determined from policy and charging control (PCC) rule information that includes an indication of using an edge enabler for a protocol data unit (PDU) session, wherein the determining that the policy indicates that the edge-anchored indication is associated with the traffic is based on the indication.

13. The system of claim 12, wherein the indication is included in a policy control section or an application function (AF) influenced traffic steering enforcement control section of the PCC rule information.

14. The system of claim 7, wherein the policy associates the edge-anchored indication with the traffic by at least using a service data flow (SDF) filter.

15. The system of claim 14, wherein the one or more memory store further instructions that, upon execution by the one or more processors, configure the system to:
determine a match between the traffic and the SDF filter;
determine that the policy is applicable based on the match; and
determine, from subscription data associated with the UE and based on the policy being applicable, an authorization for the edge-anchored indication, wherein sending the edge-anchored indication to the UE is further based on the authorization.

16. The system of claim 7, wherein the policy is determined from policy and charging control (PCC) rule information, and wherein the one or more memory store further instructions that, upon execution by the one or more processors, configure the system to:
receive a first request of the edge application or the edge application server indicating that the traffic is to be edge-anchored; and
update, based on the first request, the PCC rule information by at least updating the policy to indicate that the edge-anchored indication is associated with the traffic.

17. The system of claim 16, wherein the one or more memory store additional instructions that, upon execution by the one or more processors, configure the system to:
receive a second request of the edge application or the edge application server indicating that the traffic is to no longer be edge-anchored; and
update, based on the second request, the PCC rule information by at least updating the policy to indicate that the traffic is no longer edge-anchored.

18. The system of claim 16, wherein the one or more memory store additional instructions that, upon execution by the one or more processors, configure the system to:
verify that the first request is received from an application function (AF) authorized to indicate that the traffic is to be edge-anchored.

19. One or more non-transitory computer-readable storage media storing instructions, that when executed on a network, cause the network to perform operations comprising:
receiving, from a user equipment (UE), a request to establish a protocol data unit (PDU) session with the network;
determining, based on subscription data associated with the UE, an authorization for the UE to receive an edge-anchored indication from the network, wherein the edge-anchored indication facilitates avoiding a UE switch of traffic from being sent via the network to being sent via a different network, the traffic associated with an edge application or an edge application server; and
sending, based on the authorization, the edge-anchored indication to the UE.

20. The one or more non-transitory computer-readable storage of claim 19, wherein the operations further comprise:
determining that the traffic is associated with a policy; and
determining that the policy indicates that the edge-anchored indication is associated with the traffic, wherein sending the edge-anchored indication to the UE is further based on the policy.
